(19) United States
(12) Patent Application Publication
(10) Pub. No.: US 2012/0186050 A1
(43) Pub. Date: Jul. 26, 2012

(54) RELEASABLE LOCKING CLIP

(75) Inventor: Paul Justin, Victoria (AU)

(73) Assignee: MAKEDO PTY LTD., Victoria (AU)

(21) Appl. No.: 13/496,985

(22) PCT Filed: Sep. 17, 2010
(86) PCT No.: PCT/AU2010/001211

§ 371 Date: Mar. 19, 2012

(30) Foreign Application Priority Data
Sep. 18, 2009 (AU) 2009904532

(51) Int. Cl. F16B 2/06

(52) U.S. Cl. 24/457; 24/455

(57) ABSTRACT

A releasable locking clip for selective engagement with a connecting pin, the releasable locking clip comprising a fastening member displaceable from a pin engaging position to a pin disengaging position. The application of opposed compressive forces to the releasable locking clip displaces the fastening member to the pin disengaged position. In an alternative embodiment, a releasable fastener is formed by an elongate strap, a housing formed at a first end of the strap and having an aperture extending therethrough for receiving a second end of the strap, a fastening member displaceable from a pin engaging position to a pin disengaging position, and an actuation member responsive to the application of opposed manual compressive forces to actuate the fastening member from the pin engaging position to the pin disengaging position.

### FIELD OF THE INVENTION

This invention relates generally to a fastener for binding, securing or retaining articles together, and more particularly to a releasable locking clip for a fastener.

### DESCRIPTION OF THE RELATED ART

Fasteners, ties and like devices have long been provided to join or bind items together and are well known in the art. Generally such fasteners and ties comprise a long strap member that forms a circular loop that connects back to itself, around one or more items to bind them together.

These ties are typically available in a non-releasable version, which makes re-use of the tie impossible. Though releasable versions which may be re-used are available, these often require a special tool to release the strap member, or the method of release is awkward and difficult to perform. Several known locking clips include a short release lever or extension extending from a locking pawl sufficiently beyond the locking clip to allow user manipulation of the lever or extension to pivot the pawl out of engagement with the teeth or rungs on the cable tie and thereby release the strap from the head. In releasing the tie, the strap typically must be pulled at least a short distance through the locking clip in the strap tightening direction to allow the pawl to pivot out of engagement with the strap. Such methods of release are difficult and cumbersome.

Accordingly a need remains for a releasable locking clip that can be released and re-used without requiring special tools. Additionally, a need remains for a releasable fastener adapted for connecting or retaining articles and the like together which releasably secures the articles together.

### SUMMARY OF THE INVENTION

In accordance with the present invention, an improved releasable locking clip is provided that includes several novel features that render it more efficient and easier to use than prior devices. The releasable locking clip of the present invention is re-usable, readily adjustable and/or releasable in “both” directions, is adjustable and/or releasable by the use of opposed compressive forces, and requires significantly less strength and/or dexterity to adjust or release.

According to a first aspect, this invention resides broadly in a releasable locking clip for selective engagement with a connecting pin, the releasable locking clip comprising a fastening member displaceable from a pin-engaging position to a pin-disengaging position, wherein the application of opposed compressive forces to the locking clip displaces the fastening member to the pin-disengaged position.

In one preferred embodiment, the releasable locking clip further comprises a first release member and a second release member adapted to receive the opposed compressive forces. Preferably, the first and second release members are located at opposite sides of the releasable locking clip and are adapted to be manually actuated.

In a preferred embodiment, the first and second release members are joined to the fastening member by a bridging member adapted to move in a direction orthogonal to the opposed compressive forces.

In another aspect, the invention resides broadly in a releasable fastener, comprising an elongate strap, a housing formed at a first end of the strap, the housing having an aperture extending therethrough for receiving a second end of the strap, a fastening member displaceable from a pin-engaging position to a pin-disengaging position, and actuation means responsive to the application of opposed manual compressive forces to actuate the fastening member from the pin-engaging position to the pin-disengaging position.

In one preferred embodiment, the actuation means comprises a first release member and a second release member. Preferably, the first and second release members are located at opposite sides of the housing and are adapted to be manually actuated.

In a preferred embodiment, the first and second release members are joined to the fastening member by a bridging member adapted to move in a direction orthogonal to the opposed compressive forces.

Various other preferred features and advantages will appear from the claims and from the description that follows.

### BRIEF DESCRIPTION OF THE DRAWINGS

It will be appreciated by those of relevant skill that the disclosed embodiments are merely exemplary of the invention, and that the invention may be embodied in various and alternative forms. The invention will now be described in a non-limiting manner with reference to the accompanying drawings which illustrate a preferred embodiment of the invention, wherein:

FIG. 1 is a perspective view of a releasable locking clip for a connecting pin according to a preferred embodiment of the present invention;

FIG. 2 is cross sectional view through the releasable locking clip;

FIG. 3A is a top elevation view of the releasable locking clip;

FIG. 3B is a first side elevation view of the releasable locking clip;

FIG. 3C is a second side elevation view of the releasable locking clip of FIG. 3B rotated through 90°;

FIG. 3D is a bottom elevation view of the releasable locking clip;

FIGS. 4A to 4D are illustrations depicting the preferred dimensions of the releasable locking clip according to a preferred embodiment of the present invention;

FIGS. 5A to 5D are perspective views illustrating the releasable locking clip at various positions along a connecting pin;

FIG. 6A is a side elevation view of the releasable locking clip in an unlocked position on the connecting pin;

FIG. 6B is a cross sectional view taken along line M-M of FIG. 6A;

FIG. 6C is an enlarged detail view of the area circled in FIG. 6B;

FIG. 7A is a side elevation view of the releasable locking clip in a locked position on the connecting pin;

FIG. 7B is a cross sectional view taken along line O-O of FIG. 7A;

FIG. 7C is an enlarged detail view of the area circled in FIG. 7B;

FIG. 8A is a perspective view of a releasable fastener according to another preferred embodiment of the present invention;

FIG. 8B is an enlarged detail view of the area encircled by arrow A in FIG. 8A;

FIG. 9A is a top elevation view of the releasable fastener;

FIG. 9B is a first side elevation view of the releasable fastener;

FIG. 9C is a bottom elevation view of the releasable fastener;

FIG. 10 is a perspective view of a further alternative embodiment of the releasable locking clip;

FIG. 11 is a perspective view of another alternative embodiment of the releasable locking clip incorporating a release tab;

FIG. 12A is a perspective view of a releasable fastener according to an alternative preferred embodiment of the present invention;

FIG. 12B is a cross sectional view taken along line O-O of FIG. 12A;

FIG. 13A is a top elevation view of the releasable fastener; and

FIG. 13B is a side elevation view of the releasable fastener.

It will be appreciated by those of relevant skill that the figures are not necessarily to scale, with some features exaggerated or minimised to show details of particular components.

Like numerals in the drawings refer to like parts.

### DETAILED DESCRIPTION OF PREFERRED EMBODIMENTS

In the following discussion and in the claims that follow, the term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment”, “alternative embodiment” and the like mean “one or more (but not all) embodiments of the disclosed invention(s)”, unless expressly specified otherwise. A reference to “another embodiment” in describing an embodiment does not imply that the referenced embodiment is mutually exclusive with another embodiment (e.g., an embodiment described before the referenced embodiment), unless expressly specified otherwise.

Numerous references to a particular embodiment does not indicate a disclaimer or disavowal of additional, different embodiments, and similarly references to the description of embodiments which all include a particular feature does not indicate a disclaimer or disavowal of embodiments which do not include that particular feature. A clear disclaimer or disavowal in the present application shall be prefaced by the phrase “does not include” or by the phrase “cannot perform”.

The terms “including”, “comprising” and variations thereof mean “including but not limited to”, unless expressly specified otherwise. The terms “a”, “an” and “the” mean “one or more”, unless expressly specified otherwise. The term “plurality” means “two or more”, unless expressly specified otherwise.

The functionality and/or the features of a single device or component that is described may be alternatively embodied by one or more other devices or components which are described but are not explicitly described as having such functionality/features. Thus, other embodiments need not include the described device or component itself, but rather can include the one or more other devices or components which would, in those other embodiments, have such functionality/features.

No embodiment of method steps or device elements described in the present application constitutes the invention claimed herein, or is essential to the invention claimed herein, or is coextensive with the invention claimed herein, except where it is either expressly stated to be so in this specification or expressly recited in a claim.

The preambles of the claims that follow recite purposes, benefits and possible uses of the claimed invention only and do not limit the claimed invention.

The present disclosure is not a literal description of all embodiments of the invention(s). Also, the present disclosure is not a listing of features of the invention(s) which must be present in all embodiments.

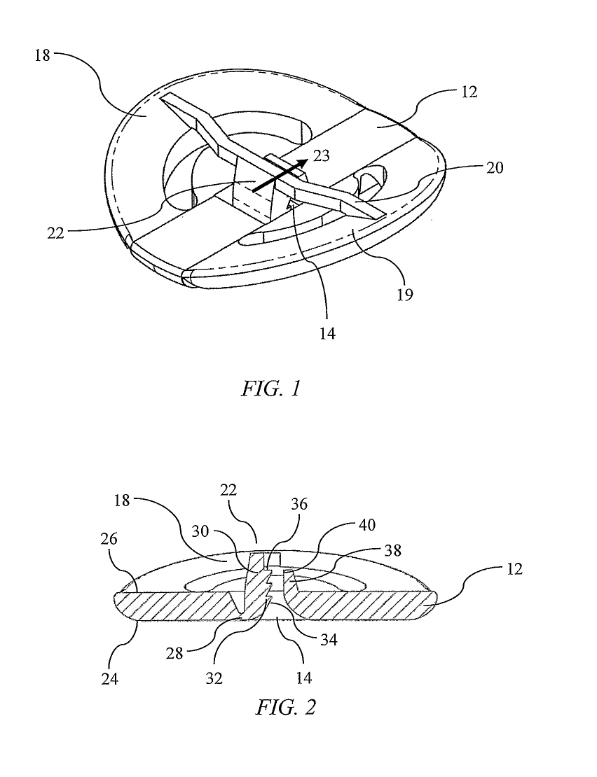

Turning now to FIG. 1, there is shown a releasable locking clip 10 manufactured in accordance with a preferred embodiment of the present invention. The releasable locking clip 10 has a housing 12 and an aperture 14 which extends through the housing. Aperture 14 is sized to receive the shank of a connecting pin (not shown).

The releasable locking clip 10 includes two opposed release members, first release member 18 and second release member 19 which are joined by a bridging member 20 to a fastening member 22. Preferably, first release member 18 and second release member 19 each comprise a flange which is angled upwardly away from the bottom surface of the housing 12.

In a preferred embodiment, bridging member 20 is resiliently deformable and is adapted to bias fastening member 22 in the direction of arrow 23 so as to securely retain the shank of the connecting pin when inserted. To facilitate manual activation of the releasable locking clip 10, the bridging member 20 has a longitudinal axis substantially orthogonal to, and coplanar with, a longitudinal axis of the fastening member 22. The longitudinal axis of the fastening member is parallel to the direction of insertion of the connecting pin. This “T” shaped alignment of the axes allows opposed compressive forces applied to the release members to be transferred to an orthogonal force for displacing the fastening member to the pin-disengaged position. The curved or stepped shaped of bridging member 20 also facilitates lateral movement of the bridging member towards an outer edge of the locking clip.

The releasable locking clip 10 may be manufactured from a number of various materials in various forms, but is preferably moulded from a flexible, resilient material such as plastic, nylon or a high modulus elastomer. An elastomeric material such as thermoplastic polyurethane (TPU) enables the releasable locking clip to be flexible and non-abrasive. The elastomeric material provides the releasable locking clip with a high coefficient of friction against the shank of the connecting pin when engaged. If made from plastic, nylon or a high modulus elastomer, releasable locking clip 10 is preferably of a one-piece construction.

In one preferred embodiment, the releasable locking clip 10 may be made from nylon 6 or nylon 66. In an alternative preferred embodiment, the releasable flocking clip 10 may be made from a composite, for example nylon reinforced with glass fibres.

FIG. 2 shows a cross section through housing 12 of the releasable locking clip 10. The housing 12 includes a bottom surface 24 and a top surface 26 through which aperture 14 extends. A fastening member 22 is located adjacent the aperture 14 for releasably engaging the shank of a connecting pin. In a preferred embodiment, fastening member 22 comprises a pawl 30 integrally attached at 28 to the housing 12. Pawl 30 extends upwardly into the aperture 14 in a position to be contacted by the shank when it is inserted into the aperture.

The pawl 30 is provided with one or more laterally extending teeth 32 having an oblique ratchet surface 34 and a horizontal retaining surface 36. Teeth 32 are adapted to respectively engage with the teeth upon the shank of a connecting pin to lock the connecting pin to the releasable locking clip 10. Furthermore, the pawl 30 is pivotably mounted so as to be able to pivot and return to the vertical position after deflection. Preferably, the pawl and bridging member form a substantially “T” shaped configuration at the region where the pawl and bridging member connect.

In an alternative embodiment, the fastening member 22 may be integral to aperture 14, which may then be deformed or expanded to allow for the insertion and removal of the connecting pin. In alternative embodiments, fastening member 22 may comprise a rachet, latch, detent or the like which cooperates with the connecting pin.

Integrally formed with the housing 12 is a flexible tang 38 or tongue. The tang 38 is generally flat or planar and has a proximal side 40 which forms one side of aperture 14. Proximal, as used in this application, refers to the side of a component or object which is nearest to the aperture 14. Distal, as used in this application, refers to the side of a component that is farthest from the aperture 14. To provide increased strength, the distal side of tang 38 is sloped such that the base of tang 38 is wider than the tip of the tang.

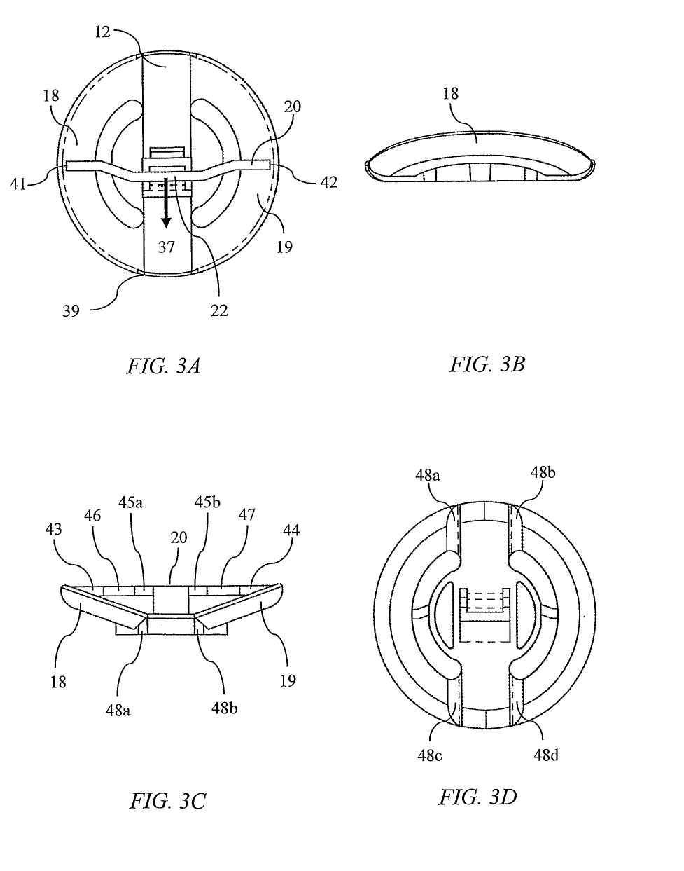

The upper portion of fastening member 22 is connected to bridging member 20 as shown in FIG. 3A. By actuating first release member 18 and second release member 19, such as by the application of opposed compressive forces, bridging member 20 urges fastening member 22 to pivot radially in the direction of arrow 37 towards the outer edge 39 of housing 12. Preferably, first release member 18 and second release member 19 are manually actuated, such as by a user gripping the release members between their thumb and index finger. As will be appreciated, the act of gripping the releasable locking clip applies a compressive force to first end 41 and second end 42 of bridging member 20 which counteracts the biasing force which urges fastening member 22 towards the shank of an inserted connecting pin.

In a preferred embodiment, with reference to FIGS. 3B to 3D, a first end section 43 and second end section 44 form a primary axis of bridging member 20. Release sections 45a and 45b are offset from the primary axis, and are joined to first end section 43 and second end section 44 by sections 46 and 47, respectively. Of course, it will be understood that the bridging member 20 may be designed in various ways such that a compressive force applied to both ends of the bridging member along a first axis is translated into a force substantially orthogonal to the first axis for disengaging the fastening member. By displacing the pawl from a connecting pin-engaging position to a connecting pin-disengaging position, an inserted connecting pin may be easily removed, or the releasable locking clip may be readily adjusted or released.

Further, the releasable locking clip preferably has cut-out portions 48a, 48b, 48c and 48d at the point where first release member 18 and second release member 19 join the housing 12. Specifically, the cut-out portions 48a, 48b, 48c and 48d are formed as a substantially U-shaped or V-shaped groove or the like cut from the outer surface toward the middle of the release members so as to increase their overall flexibility. The increased flexibility of first release member 18 and second release member 19 serves to decrease the amount of force required to adjust or remove the releasable locking clip from the connecting pin.

In an alternative preferred embodiment, either one of release members 18 and 19 may be immovably connected to housing 12, such that only the release member on the opposite side of the housing is adapted to move relative to the housing.

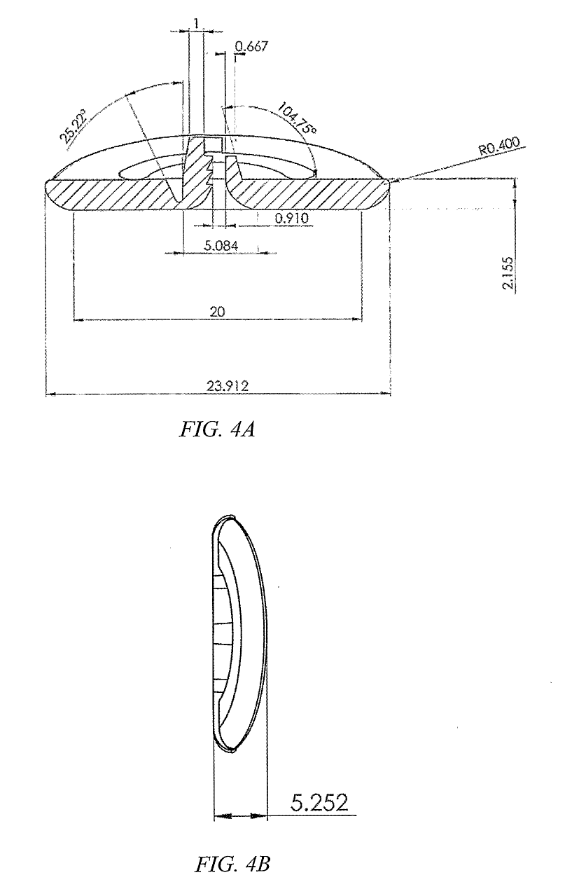

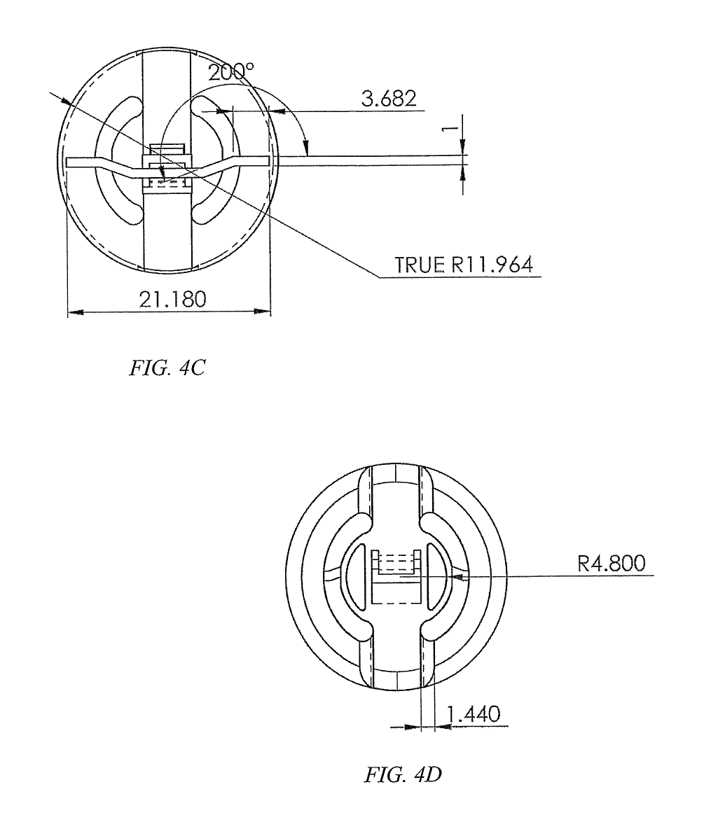

Preferred dimensions of one embodiment of the releasable locking clip, with distances in millimeters and angles in degrees, are shown in FIGS. 4A to 4D. The housing 12, fastening member 22 and tang 38 are all of a thickness to resist deformation that would permit the shank of the connecting pin to be stripped out backward under a heavy load.

The person having ordinary skill in the art would appreciate that the releasable locking clip is not limited by dimension and that the stated dimensions are merely exemplary, and that other dimensions are suitable for the releasable locking clip of the present invention. Depending on the material of manufacture, the releasable locking clip may range from a diameter of about several millimeters to about several dozen centimeters and upwards. For example, such a range could span from about 3 millimetres to about 120 centimetres or more.

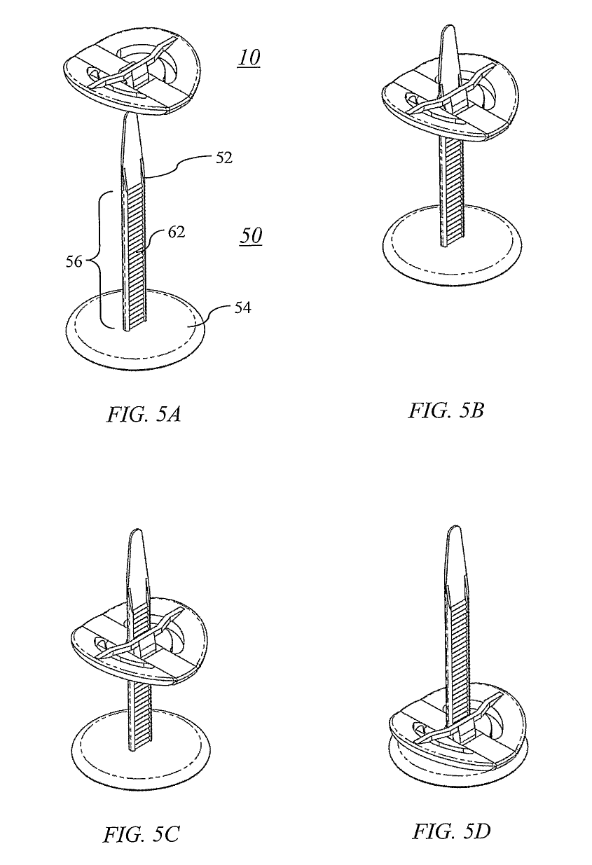

In operation the releasable locking clip would be fastened to the shank 52 of a connecting pin 50 as shown in FIGS. 5A to 5D. Connecting pin 50 includes a head 54 perpendicular to the shank 52 which is sized to prevent the connecting pin from passing through the aperture of the releasable locking clip. In a preferred embodiment, shank 52 is substantially rectangular in cross section, with one side having a centrally located longitudinal area 56 with laterally extending teeth 62.

In an alternative preferred embodiment, shank 52 may comprise laterally extending teeth on opposite sides of the shank. In a further alternative embodiment, shank 52 may be substantially circular in cross section, with laterally extending teeth that either partially or fully circumscribe the circumference of the shank.

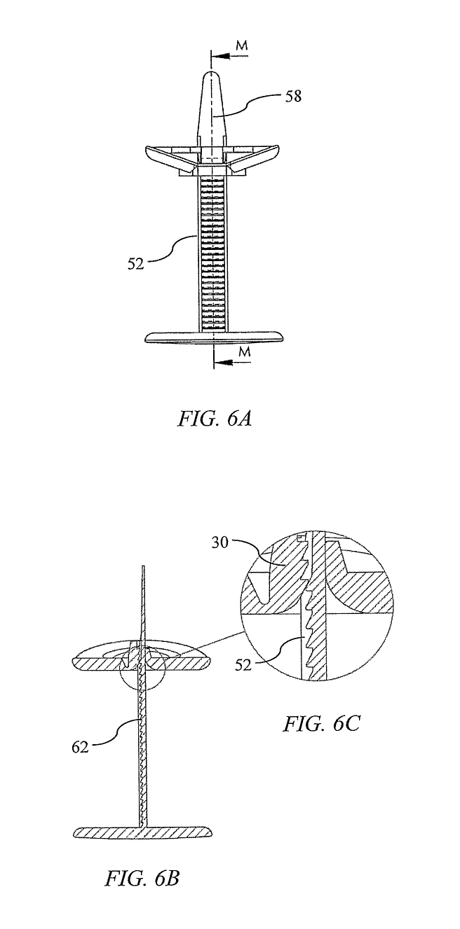

To facilitate insertion of the connecting pin 50 into the releasable locking clip 10, an upper portion 58 of shank 52 may be tapered and formed free of laterally extending teeth, as shown in FIG. 6A. As illustrated in FIGS. 6B and 6C, teeth 62 are recessed within the shank 52. In an alternative preferred embodiment, the teeth may be located above the surface of the shank. In operation, connecting pin 50 is inserted through an article or group of articles, with upper portion 58 inserted into the aperture 14 such that longitudinal area 56 faces pawl 30. Upper portion 58 is moved further through aperture 14 to a point where laterally extending teeth 62 meet pawl 30.

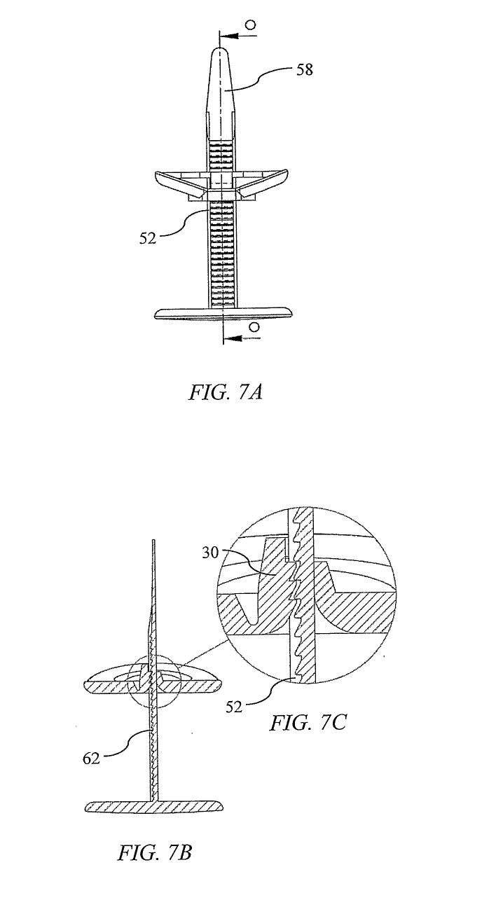

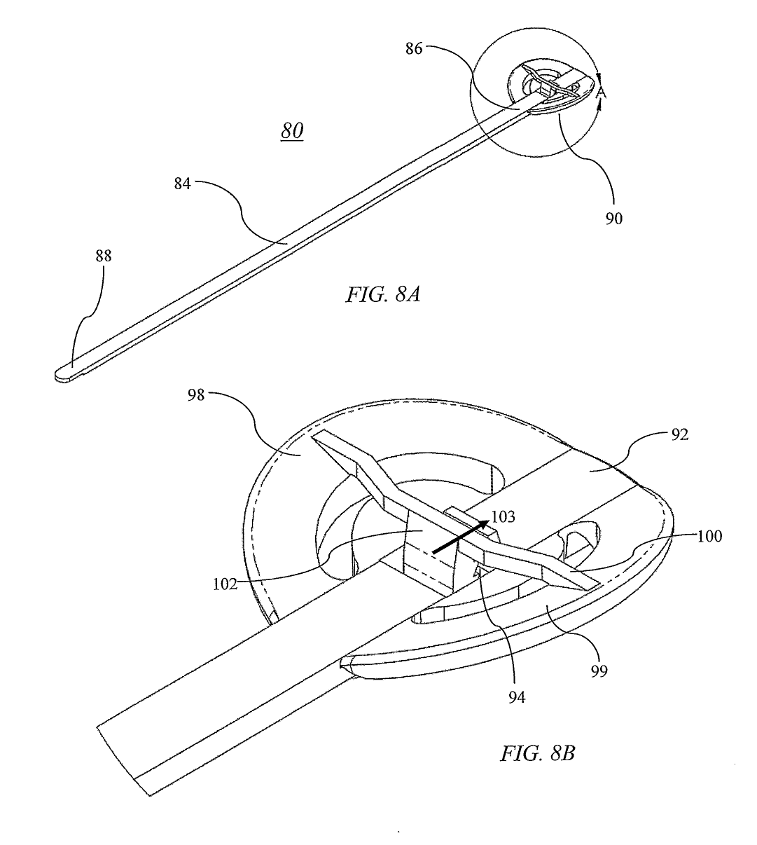

As shank 52 is moved through aperture 14, laterally extending teeth 62 will ratchetably engage pawl 30, as shown in FIGS. 7A to 70. Next, connecting pin 50 and releasable locking clip 10 are moved together to securely retain an article or group of articles to be joined. The releasable locking clip 10 can be released from the connecting pin 50 when a sufficient force is applied to first release member 18 and second release member 19.

In an alternative embodiment, the releasable locking clip may be manufactured from metal such as various grades of steel, titanium, aluminium and the like. Also other materials, such as wood or ceramic materials, or a combination of materials can be used to construct the releasable locking clip. Rather than being integrally formed, the first release member, second release member and fastening member may be resiliently hingedly connected to the housing. The bridging member is also resiliently hingedly connected or otherwise articulated such that a compressive force applied to both ends of the bridging member along a first axis is translated into a force substantially orthogonal to the first axis for disengaging the fastening member.

If made from metal, the releasable clip may be painted, powder coated, chrome-plated, cadmium-plated, anodize-plated, or otherwise finished to provide an aesthetically pleasing appearance and to protect the device from environmental effects. Other suitable coatings may include moulded rubber, fusion bonded epoxies, extruded polyethylene, and combinations thereof or the like. Alternatively, the releasable locking clip or various parts thereof may be covered with a protective sleeve. The protective sleeve may comprise fabric, foam, aluminium alloy, a polymer coating, a glass reinforced thermoset material (such as, for example, a glass or fibreglass reinforced plastic) or the like. Individual components of the releasable locking clip may be protected by differing materials.

Referring now to FIGS. 8A and 8B, there is shown a releasable fastener 80 constructed in accordance with the principles of the present invention. Releasable fastener 80 comprises an elongate strap 84 and a releasable locking clip 90 connected at a first end 86 of the strap. Releasable locking clip 90, which is substantially identical to the construction of releasable locking clip 10, has a housing 92 and an aperture 94 which extends through the housing. Aperture 94 is sized to receive the second end 88 of the elongate strap 84. In a preferred embodiment, fastening member 102 comprises a pawl 110 integrally attached to the housing 92. Pawl 110 extends upwardly into the aperture 94 in a position to be contacted by the elongate strap 84 when it is inserted into the aperture.

The releasable fastener 80 includes two opposed release members, first release member 98 and second release member 99 which are joined by a bridging member 100 to a fastening member 102. Preferably, first release member 98 and second release member 99 each comprise a flange which is angled upwardly away from the bottom surface of the housing 92. In a preferred embodiment, bridging member 100 is resiliently deformable and is adapted to bias fastening member 102 in the direction of arrow 103 so as to securely retain the elongate strap 84 when inserted.

The releasable fastener 80 may be manufactured from a number of various materials in various forms, but is preferably moulded from a flexible, resilient material such as plastic, nylon or a high modulus elastomer. An elastomeric material such as thermoplastic polyurethane (TPU) enables the releasable fastener to be flexible and non-abrasive. The elastomeric material provides the releasable locking clip 90 with a high coefficient of friction against the elongate strap 84 when engaged. If made from plastic, nylon or a high modulus elastomer, releasable fastener 80 is preferably of a one-piece construction.

In one preferred embodiment, the releasable fastener 80 may be made from nylon 6 or nylon 66. In an alternative preferred embodiment, the releasable fastener 80 may be made from a composite, for example nylon reinforced with glass fibres.

In another preferred embodiment, releasable locking clip 90 and elongate strap 84 may be hingedly connected or otherwise joined as an alternative to being integrally formed, and may be manufactured from differing materials such as various grades of steel, titanium, aluminium and the like. Also other materials, such as wood or ceramic materials, or a combination of materials can be used to construct the releasable fastener.

If made from metal, the releasable fastener may be painted, powder coated, chrome-plated, cadmium-plated, anodize-plated, or otherwise finished to provide an aesthetically pleasing appearance and to protect the device from environmental effects. Other suitable coatings may include moulded rubber, fusion bonded epoxies, extruded polyethylene, and combinations thereof or the like. Alternatively, the releasable fastener or various parts thereof may be covered with a protective sleeve. The protective sleeve may comprise fabric, foam, aluminium alloy, a polymer coating, a glass reinforced thermoset material (such as, for example, a glass or fibreglass reinforced plastic) or the like. Individual components of the releasable fastener may be protected by differing materials.

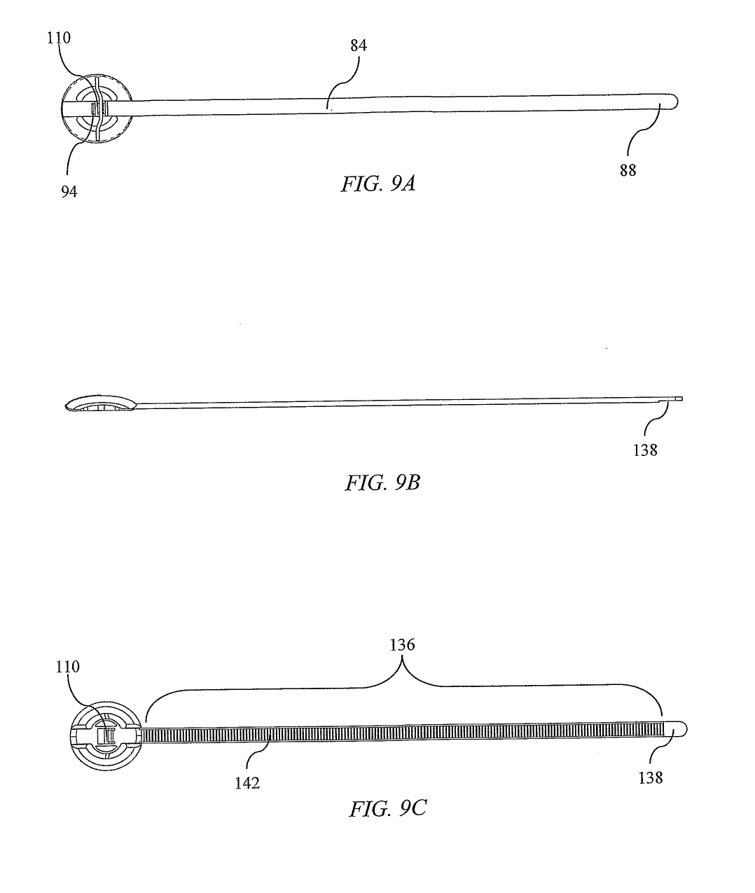

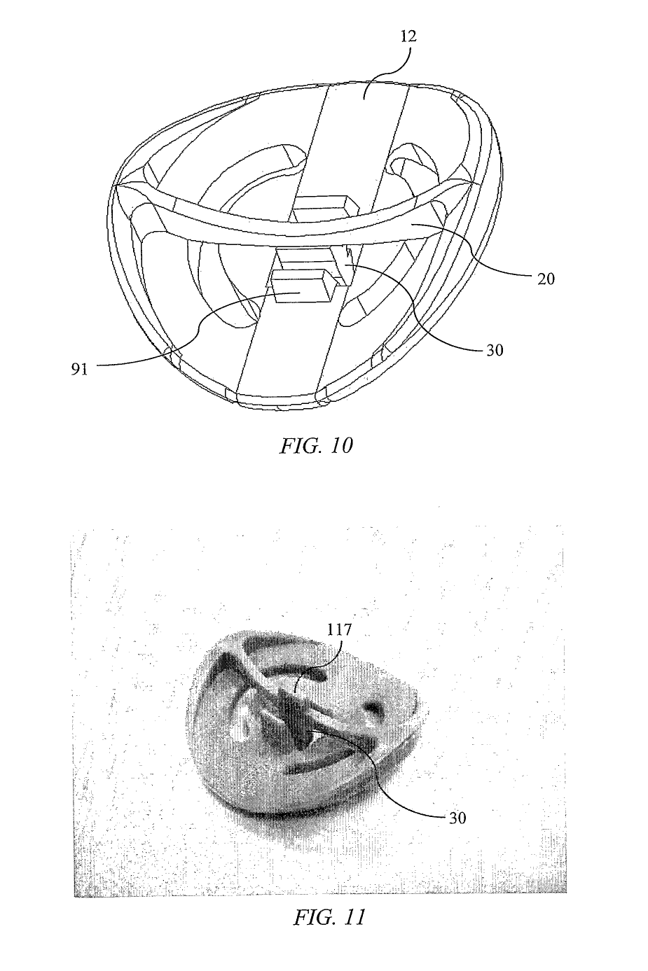

In a preferred embodiment, as shown in FIGS. 9A to 9C, elongate strap 84 is substantially rectangular in cross section, with one side having a centrally located longitudinal area 136 with laterally extending teeth 142. In operation, elongate strap 84 is wrapped around an article or group of articles, with second end 88 inserted into the aperture 94 such that longitudinal area 136 faces pawl 110. Second end 88 is moved further through aperture 94 to a point where laterally extending teeth 142 meet pawl 110. As elongate strap 84 is moved through aperture 94, laterally extending teeth 142 will ratchetably engage pawl 110. As second end 88 is pulled through aperture 94, elongate strap 84 is snugly drawn about the article or group of articles to be bundled.

To facilitate insertion of the second end 88 into the releasable locking clip 90, an upper portion 138 of elongate strap 84 may be tapered and formed free of laterally extending teeth.

To prevent unwanted deformation of the pawl due to an excessive compressive force applied to both ends of the bridging member 20, the retaining clip optionally incorporates a stop member 91 located behind pawl 30 as shown in FIG. 10. To restrict the distance the pawl can retract, the height of stop member 91 is preferably 50% to 100% of the height of the pawl. Preferably the stop member 91 is integrally formed with the housing 12. In this embodiment, bridging member 20 is more arcuate in shape and thicker than the bridging member seen in FIG. 1.

In another alternative embodiment as shown in FIG. 11, the releasable locking clip may include a release tab 117 located above the pawl 30. The release tab may be manipulated by a user to assist with the release of the pawl from the connecting pin or strap with which it is engaged. For example, when the pawl is under relatively high tension, the release tab may be actuated or grabbed by the fingernail of the user to assist in the release of the pawl.

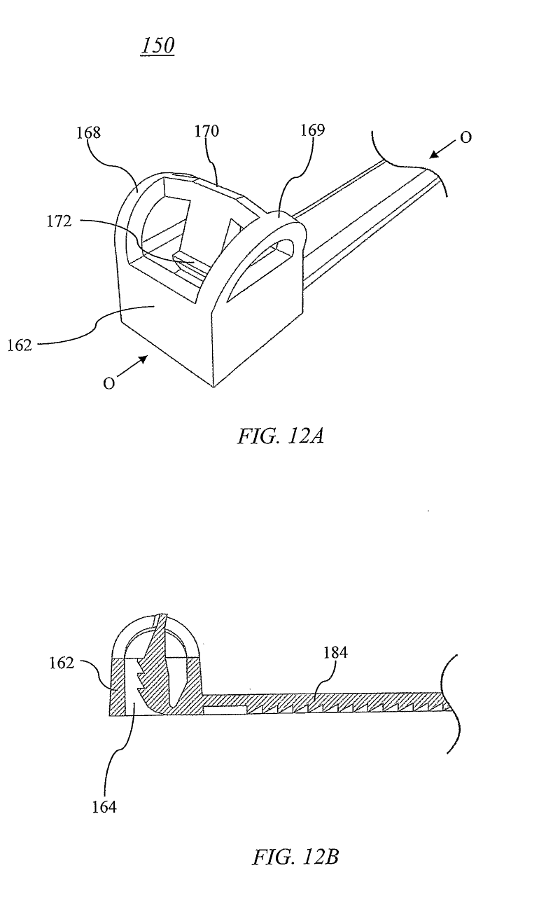

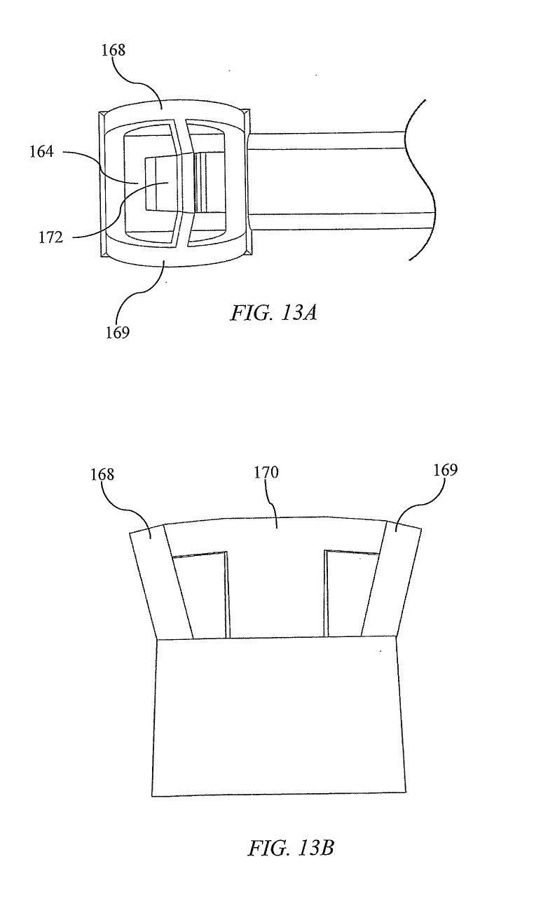

A further embodiment of the releasable locking clip, demonstrating an alternative release member and bridging member design, is shown in FIGS. 12A, 12B, 13A and 13B. Turning now to the figures, there is shown a releasable locking clip 150 comprising a housing 162 and an aperture 164 which extends through the housing. Aperture 164 is sized to receive the shank of a connecting pin.

The releasable locking clip 150 includes two opposed release members, first release member 168 and second release member 169 which are joined by a bridging member 170 to a fastening member 172. Preferably, first release member 168 and second release member 169 each comprise an arcuate member which is joined to the top of housing 162 and angled upwardly away from the housing. Release members 168 and 169 may be of any shape suitable for manual actuation. Bridging member 170 is generally arcuate in shape which facilitates lateral movement of the bridging member towards an outer edge of the locking clip when opposed compressive forces are applied to release members 168 and 169. The releasable locking clip 150 may be integrally formed with a strap 184, which may be of any desired length.

As will be appreciated, the invention as defined by the appended claims is both releasable and re-usable. Although the invention has been disclosed in its preferred forms, it is to be understood that the above embodiments have been provided only by way of exemplification of this invention, and that further modifications and improvements thereto, as would be apparent to persons skilled in the relevant art, are deemed to fall within the broad scope and ambit of the current invention described and claimed herein.

The reference to any prior art in this specification is not, and should not be taken as, an acknowledgement or any form of suggestion that the prior art forms part of the common general knowledge.

1. A releasable locking clip for selective engagement with a connecting pin, the releasable locking clip comprising:
a fastening member displaceable from a pin-engaging position to a pin-disengaging position;
a first manually actuable release member;
a second manually actuable release member;
wherein the application of opposed compressive forces to the first and second release members displaces the fastening member to the pin-disengaged position.

2. The releasable locking clip as claimed in claim 1, wherein the first and second release members are located at opposite sides of the releasable locking clip.

3. The releasable locking clip as claimed in claim 2, wherein the first and second release members are joined to the fastening member by a bridging member.

4. The releasable locking clip as claimed in claim 3, wherein the bridging member is adapted to move in a direction substantially orthogonal to the opposed compressive forces.

5. The releasable locking clip as claimed in claim 4, wherein the bridging member is shaped such that upon application of the opposed compressive forces the bridging member moves towards an outer edge of the locking clip.

6. The releasable locking clip as claimed in claim 5, wherein the bridging member is arcuate in shape.

7. The releasable locking clip as claimed in claim 5, wherein the bridging member is stepped in shape.

8. The releasable locking clip as claimed in claim 6, wherein the fastening member comprises a pawl.

9. The releasable locking clip as claimed in claim 8, wherein the bridging member has a longitudinal axis substantially orthogonal to, and coplanar with, a longitudinal axis of the pawl.

10. The releasable locking clip as claimed in claim 9, further comprising a housing having an aperture extending therethrough for receiving the connecting pin.

11. The releasable locking clip as claimed in claim 10, wherein actuation of the first and second release members results in the pawl pivoting towards an outer edge of the housing.

12. The releasable locking clip as claimed in claim 11, wherein the pawl is integrally formed with the housing.

13. The releasable locking clip as claimed in claim 12, wherein the pawl includes one or more teeth.

14. The releasable locking clip as claimed in claim 13, wherein the first and second release members comprise movable flanges.

15. The releasable locking clip as claimed in claim 14, wherein the movable flanges are resiliently deformable.

16. The releasable locking clip as claimed in claim 7, wherein the fastening member comprises a pawl.
